(19) United States
(12) Patent Application Publication
(10) Pub. No.: US 2012/0101853 A1
(43) Pub. Date: Apr. 26, 2012

(54) SYSTEM FOR PROVIDING SECONDARY CREDIT PROTECTION FOR LIFE AND ANNUITY POLICIES, TRACKING UNPAID CLAIMS

(76) Inventors: Jeffrey S. Lange, New York, NY (US); Jeffrey M. Lewis, New York, NY (US)

(21) Appl. No.: 13/149,199

(22) Filed: May 31, 2011

Related U.S. Application Data
(60) Provisional application No. 61/349,412, filed on May 28, 2010.

(51) Int. Cl. G06Q 40/08

(52) U.S. Cl. 705/4

(57) ABSTRACT

A method for providing insurance in a distributed computing network having a server and a plurality of clients including the steps of determining a corporate bond price associated with a corporate bond of a holding company in the server, determining an interpolated swap rate for the bond based on the corporate bond price and premium in the server, determining a present weighted value of premiums associated with the corporate bond in the server, determining an overcollateralization ratio of the holding company in the server, determining implied asset volatility for the corporate bond in the server, determining an implied put price for the corporate bond and a CDS premium for the insurance company in the server, and offering a secondary credit protection product for users associated with the clients.

### CROSS-REFERENCE TO RELATED APPLICATION

This application claims priority to U.S. Provisional Patent Application No. 61/349,412, filed May 28, 2010, which is incorporated herein by reference.

### BACKGROUND OF THE INVENTION

1. Field of Invention

The present disclosure generally relates to a method and system for providing secondary credit protection for life and annuity policies. The methods and systems give the policyholder the ability to hedge a potential default of payment of the original issuing life insurance or annuity provider at term.

2. Background

Recently in the United States, a distressed economic environment has been prevalent. The largest insurer, American International Group, Inc. (AIG) received bailout money from the U.S. government to meet increased collateral obligations. Such events underline the incapacity of holding companies to deal with the current challenging credit market environment independently. There is in fact no measure as of now to determine if AIG is financially sound nor is there any means to evaluate policyholders' risk and exposure to AIG. Moreover, many major life insurance companies appear on unsure financial footing with the threat of collapse. Although the policies could be transferred to another life insurance company, there is no guarantee for the policyholder that this might actually be the case, not mentioning the potential delays of payment if collapse and/or transfer does occur.

No instrument currently exists nor is traded on the market that measures policyholders' credit risk and exposure to life operating companies and holding companies failure to pay death benefits. Only derivative instruments that evaluate debt and equity holders' risk currently exist. No credit protection instrument exists that covers the joint event of paying upon death of policyholder and prior default of the related insurer, or in the case of an annuity, the joint event of annuity payout date and prior default of the annuity issuer.

### SUMMARY OF THE INVENTION

There is no way for a policyholder to hedge the risk against policy issuers' default, which has risen multiple-fold for policyholders in the years 2008 and 2009. The credit risk of default of policy issuers can be gauged by calculating the implied 30 year credit default swap (CDS) premium on the life insurance company, which is usually a subsidiary of a holding company whose debt is traded on the market. By looking at the difference of leverage between the holding company and the life insurance company, the credit CDS premium of the life insurance company can be implied. For example, Prudential Life Insurance Company went from 72 bps at the end of 2007 to over 200 bps in 2009.

In addition to life insurance, there are many life contingent risks in deferred annuities such as fixed and variable annuities for which the present technology would be applicable. For example, many such annuities provide what are known as Guaranteed Minimum Death Benefits (“GMDB”), which are benefits at the death of the policyholder which are based upon a contract specification that can include increases based upon fixed interest rates, annual increases in market returns and the like. The GMDB would then amount to a considerable component of the annuity contract. Because the GMDB are all obligations of the life insurer's general account, the GMDB are backed only by the general financial strength of the life insurers and therefore present the same default risk bearing issues involved for life insurance.

In view of the above, a need is recognized for new methods and systems to provide life and annuity policyholders the ability to hedge issuing policy life insurance companies' credit risk. A need is also recognized for this hedge to be realizable at low cost, easy to administer, purchase and explainable to retail policyholders.

The present disclosure is directed to a subject technology including an insurance contract which provides secondary credit protection. The benefits can be targeted in various ways. In one embodiment, a separate guarantor model utilizes a third party insurance company, bank, investment bank, clearinghouse or the like in which policies may be contracted. In another embodiment, a guarantor underwrites a rider on the original policy which, for an additional premium, provides credit protection by a highly rated third party. In still another embodiment, the environment 10 includes a specifically designed CDS, over-the-counter (“OTC”) or exchange, which (i) pays out upon life insurance company default on policyholder (at that part of the capital structure) and (ii) pays out only upon the death of the holder in the case of life insurance or annuity pay date in the case of an annuity.

A benefit of the subject technology is for the policyholders to practically remove all credit risk from their life insurance or annuity policies at minimal costs. The subject technology can offer a term credit hedge as well that would be in effect for a limited period of time such as 10, 15, 20 or 30 years, to lower even further the cost to the policyholder. The calculation of the premium utilizes a shorter term and the relevant NLG Policy Premium for the term of the policy chosen. For example, the premium could be $805, $1,085, $1,425, $2,615 per $1 MM of 10 year, 15 year, 20 year and 30 year policies respectively. The contracts could be turned into permanent at term if the policyholder wants to make the contract permanent, the contract premium being re-priced at the time of being made permanent.

It should be appreciated that the subject technology can be implemented and utilized in numerous ways, including without limitation as a process, an apparatus, a system, a device, a method for applications now known and later developed or a computer readable medium. These and other unique features of the system disclosed herein will become more readily apparent from the following description and the accompanying drawings.

### BRIEF DESCRIPTION OF THE DRAWINGS

So that those having ordinary skill in the art to which the disclosed systems and methods appertains will more readily understand how to make and use the same, reference may be had to the following drawings.

FIG. 1 is a schematic diagram showing an environment for a secondary credit protection system in accordance with the subject disclosure.

FIG. 2 is a schematic block diagram of server for a secondary credit protection system implemented in accordance with the subject disclosure.

FIG. 3 is a flow diagram of a process performed by the secondary credit protection system of FIG. 2.

FIG. 4 is a spreadsheet display including financial information for two exemplary companies in the process of FIG. 3.

FIG. 5A is a top portion of a table containing exemplary data for an example of incorporating the state guarantees into the process of FIG. 3.

FIG. 5B is a bottom portion of the table of FIG. 5A.

### DETAILED DESCRIPTION OF PREFERRED EMBODIMENTS

The subject technology overcomes many of the prior art problems associated with secondary credit protection for life and annuity policies. The advantages, and other features of the systems and methods disclosed herein, will become more readily apparent to those having ordinary skill in the art from the following detailed description of certain preferred embodiments taken in conjunction with the drawings which set forth representative embodiments of the present invention and wherein like reference numerals identify similar structural elements.

Herein a computer or server is one or more digital data processing devices used in connection with various embodiments of the invention. Such a device generally can be a personal computer, computer workstation (e.g., Sun, HP), laptop computer, tablet computer, server computer, mainframe computer, handheld device (e.g., personal digital assistant, Pocket PC, cellular telephone, etc.), information appliance, printed circuit board with components or any other type of generic or special-purpose, processor-controlled device capable of receiving, processing, displaying, and/or transmitting digital data. A typical computer includes random access memory (RAM), mechanisms and structures for performing I/O operations, a storage medium such as a magnetic hard disk drive(s), and an operating system (e.g., software) for execution on the central processing unit. The computer also has input and output devices such as a keyboard and monitor, respectively.

A processor generally is logic circuitry that responds to and processes instructions that drive a computer and can include, without limitation, a central processing unit, an arithmetic logic unit, an application specific integrated circuit, a task engine, and/or any combinations, arrangements, or multiples thereof. Software or code generally refers to computer instructions which, when executed on one or more digital data processing devices, cause interactions with operating parameters, sequence data/parameters, database entries, network connection parameters/data, variables, constants, software libraries, and/or any other elements needed for the proper execution of the instructions, within an execution environment in memory of the digital data processing device(s).

A module is a functional aspect, which may include software and/or hardware. Typically, a module encompasses the necessary components to accomplish a task. It is envisioned that the same hardware could implement a plurality of modules and portions of such hardware being available as needed to accomplish the task. Those of ordinary skill will recognize that the software and various processes discussed herein are merely exemplary of the functionality performed by the disclosed technology and thus such processes and/or their equivalents may be implemented in commercial embodiments in various combinations without materially affecting the operation of the disclosed technology.

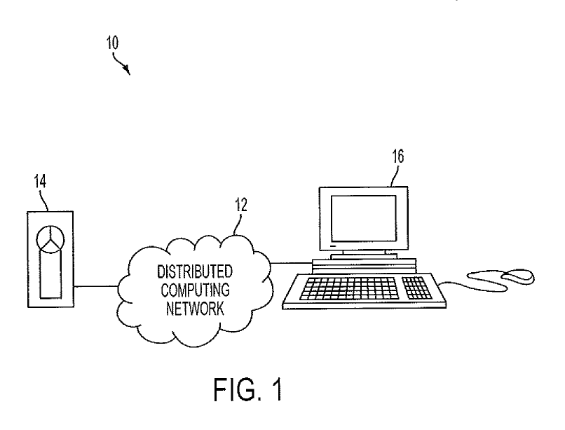

Referring now to the FIG. 1, there is a schematic block diagram of an environment 10 with a secondary credit protection system embodying and implementing the methodology of the present disclosure. In one embodiment, the secondary credit protection system determines: a corporate bond price associated with a corporate bond of the holding company; an interpolated swap rate for the bond based on the corporate bond price and premium; a present weighted value of premiums associated with the corporate bond; an overcollateralization ratio of the holding company; implied asset volatility for the corporate bond; and an implied put price for the corporate bond and a CDS premium for the insurance company. In another embodiment, the secondary credit protection system performs a method that determines: a corporate bond price associated with a corporate bond of a holding company in the server; an interpolated swap rate for the bond based on the corporate bond price and premium in the server; a present weighted value of premiums associated with the corporate bond in the server; an overcollateralization ratio of the holding company in the server; implied asset volatility for the corporate bond in the server; and an implied put price for the corporate bond and a CDS premium for the insurance company in the server to offer a secondary credit protection product for users associated with the clients.

The secondary credit protection system is user-interactive and self-contained so that users need not leave venture to another address within a distributed computing network 12 to access a various information. The following discussion describes the structure of such an environment 10 but further discussion of the application programs and modules that embody the methodology of the present invention is described elsewhere herein.

The environment 10 includes one or more servers 14 which communicate with and as part of the distributed computer network 12 via communication channels, whether wired or wireless, as is well known to those of ordinary skill in the pertinent art. In preferred embodiments, the distributed computer network 12 is a local area network or the Internet. For simplicity, one server 14 is shown. Server 14 can host multiple sites and houses multiple databases necessary for the proper operation of the secondary credit protection system in accordance with the subject technology.

The server 14 is any of a number of servers known to those skilled in the art that operably connect a plurality of computers or clients 16 to the distributed computer network 12. For simplicity, only one client 16 is illustrated. The clients 16 have displays and an input device(s) as would be appreciated by those of ordinary skill in the pertinent art. Clients 16 typically provide user access to the environment 10. The clients 16 can also utilize a removable computer readable medium such as a CD or DVD type of media that is inserted therein for reading and/or writing to the removable computer readable media. The servers 12 and clients 16 may actually be configured identically.

Distributed computer network 12 may include any number of network systems well known to those skilled in the art. For example, distributed computer network 12 may be a combination of local area networks (LAN), wide area networks (WAN), or, as is well known. For the Internet, the preferred method of accessing information is the World Wide Web because navigation is intuitive and does not require technical knowledge.

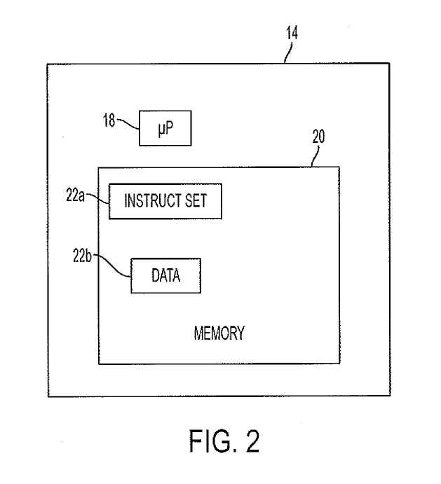

Referring now to FIG. 2, a schematic block diagram of server 14 for a secondary credit protection system implemented in accordance with the subject disclosure is shown. The server 14 typically includes a central processing unit 18 including one or more microprocessors such as those manufactured by Intel or AMD connected to memory 20. The memory 20 may be any combination and amount of random access memory (RAM), long term storage medium such as a magnetic hard disk drive, and the like. The server 14 will also include mechanisms and structures for performing I/O operations and an operating system for execution on the central processing unit 18. The hard disk drive of the server may be used for storing data, client applications and the like utilized by client applications as well as modules 22a, 22b. The hard disk drive of the server 14 typically provides booting and storing the operating system, other applications or systems that are to be executed on the server 14 as well as paging and swapping between the hard disk and the RAM.

The flow chart herein illustrates the structure or the logic of examples of the present technology, possibly as embodied in computer program software for execution on a server, a computer, digital processor or microprocessor. Those skilled in the art will appreciate that the flow chart illustrates the structures of the computer program code elements, including logic circuits on an integrated circuit, that function according to the present technology. As such, the present technology may be practiced by a machine component that renders the program code elements in a form that instructs a digital processing apparatus (e.g., computer) to perform a sequence of function step(s) corresponding to those shown in the flow charts.

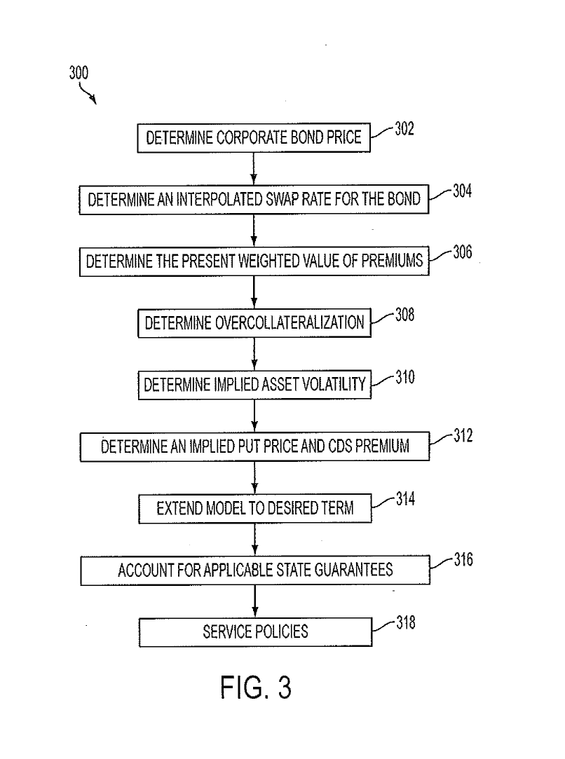

Referring now to FIG. 3, there is illustrated a flowchart depicting a process 300 for estimating a credit default swap (CDS) risk premium for a life insurance company in accordance with an embodiment of the present technology.

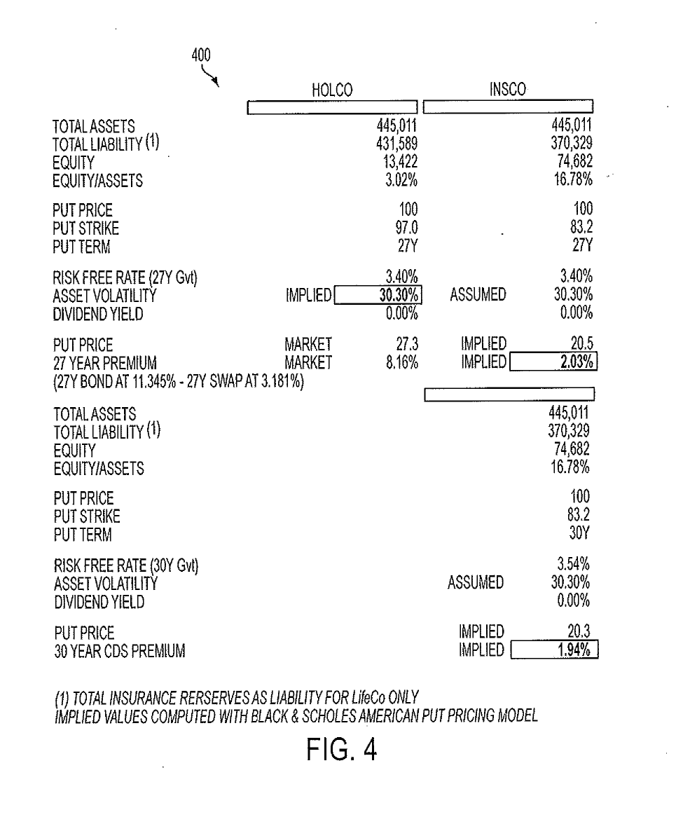

The process 300 estimates the CDS risk premium for the life insurance company from a holding company's corporate debt that is traded on a secondary market. In the following example, INSCO is short for life insurance company and HOLCO is short for the holding company. Referring also to FIG. 4, exemplary financial data for ISNCO and HOLCO is shown.

At step 302, the process 300 determines the trading price of a 27 year corporate bond for the HOLCO. For example as shown in FIG. 4, the HOLCO 27 year corporate bond trades at 11.345% yield. At step 304, the process determines an interpolated swap rate, which in this example is 3.181%, with an implied 27 year HOLCO premium of 8.16% as of the same date (11.345−3.181=8.164).

At step 306, assuming a recovery rate of 60% in case of a company default by INSCO, the process 300 determines the present value of the premium cash flows over 27 years, weighted by the implied probability of the company survival according to, for example CDS Premium/[1-Recovery Rate]. In this example, the weighted present value equals 20.4%.

At step 308, the process 300 extracts the amount of leverage of HOLCO to determine an overcollateralization ratio. The leverage can be determined from HOLCO's balance sheet as of the end of the year and adjusted for separate accounts. For example, the overcollateralization ratio may be total assets divided by total liabilities. Pulling the amounts from FIG. 4, the overcollateralization ratio for HOLCO is 445,011/431,589=100/97.

At step 310, the process 300 uses a Black & Scholes (B&S) pricing model for American Put Option to determine the implied asset volatility σₐ, based on the following assumptions: i) the 27 year risk-free rate is 3.4%; ii) a 0% dividend yield; iii) a 27 year term; iv) a current price of US$100; v) a strike price of US$97; and a put price that is equal to the present value of premiums as calculated above, i.e., 20.4%. As shown in FIG. 4, the resulting implied asset volatility for this example is σₐ=30.3%.

At step 312, the process 300 determines an implied put price and 27 year CDS premium for INSCO. The process 300 uses the implied asset volatility (e.g., 30.3%) in the B&S model to find out the implied CDS Premium for INSCO by stripping out the liabilities of anything that is not insurance reserves related. The stripped out overcollateralization ratio for INSCO is then 445,011/370,329=100/83.2. By only changing the strike of the option in the B&S model, the process 300 determines an implied put price of 20.5, which equates to a 27 year CDS premium for INSCO of 2.03%, using the same PV methodology as above.

At step 314 of FIG. 3, the process 300 extends the model to a 30 year term, using a 30 year risk-free rate of 3.54%, which is empirically determined from actual data. In the example of FIG. 4, the process 300 determines a put price of 20.3, which equates to a 30 year CDS premium of 1.94% for INSCO. As a result of the process 300, a server 14 running in the environment 10 can create and offer secondary credit protection by determining a 30 year CDS premium for a given company such as an insurance company.

### State Guarantee Modification

Each state has guaranty funds to help pay the claims of a financially impaired insurance company, but the states only insure a small portion of policyholder risk. For example, the maximum death benefit with respect to any one life changes from one state to the other, and ranges from $250K in California to $500K in New York and New Jersey. The maximum liability for present value of an annuity contract ranges from $100K in most states to $500K in New York for instance.

Typically, the amounts available are not enough to cover most of the total coverage of a policyholder in the case where the insurer defaults. Moreover, state guaranty funds are not pre-funded, except in the state of NY, and still pose systemic risk. However, the state guarantees are preferably taken into account when pricing the invented hedging instrument for policyholders. Still referring to FIG. 3, the process 300 proceeds to step 316 in which the applicable state guarantees are taken into account.

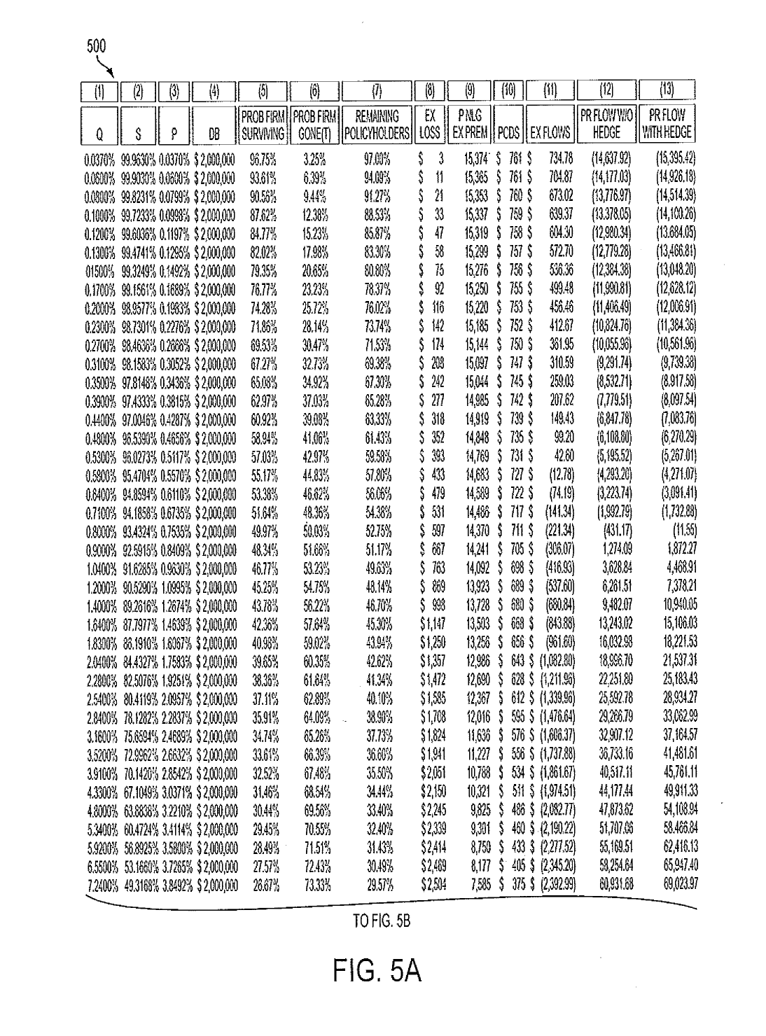

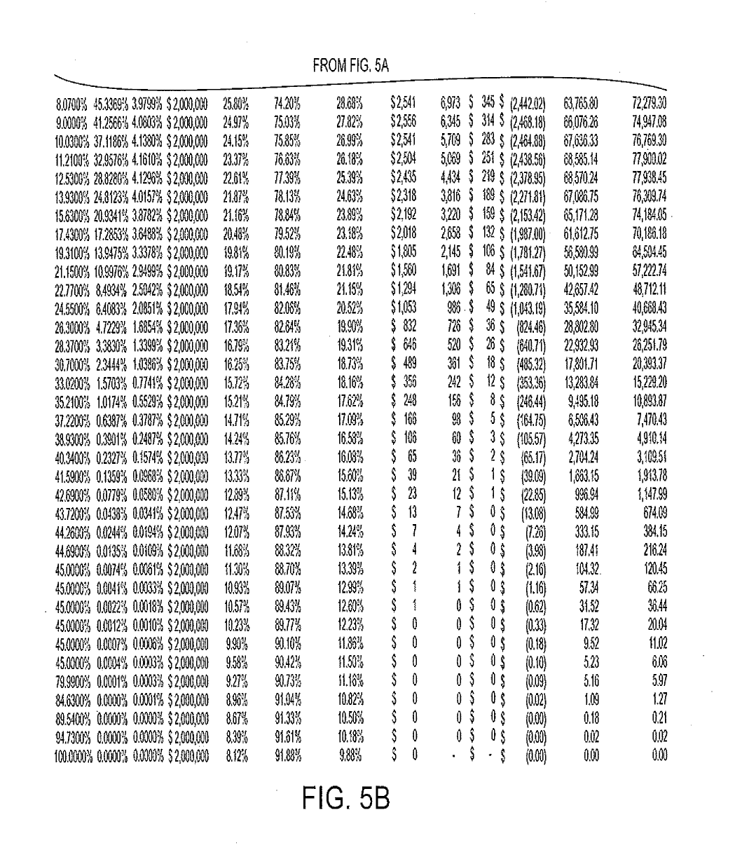

Referring now to FIGS. 5A and 5B, a table 500 containing exemplary data for an example of incorporating the state guaranty is shown. The table 500 represents model data relating to a policy size of $2MM, held by a female of 45 years old in the state of New York. As noted above, New York has a $500,000 state fund guarantee. The process 300 assumes that the life insurance company's CDS premium is 130 bps (calculated as described above), implying a hazard rate of 3.25% for 60% recovery rate (using CDS Premium/[1-Recovery Rate]). The market lifetime no-lapse guarantee premium (“NLG Premium”) is assumed to be $7,690 per $1MM of life insurance policy, assuming a discount rate of 7.0%.

In FIGS. 5A and 5B, column (1) shows the force of mortality or hazard rates Q for a 45 year old from 2008 SOA Preferred Mortality Tables with Select Factors. Column (2) is the probability of surviving S to year T. In first year, S(1), the probability of surviving year 1, is one minus the hazard rate or probability of death P in column (3). S(2)=S(1) * [one—the hazard rate for year 2 in column (3)]. Hence, S(N)=S(N−1) * [1−P(N)].

Column (3) is the probability of death P in year T. The probability of dying P(1) in year 1 is equal to the hazard rate in year 1 from column (3). P(2) is equal to S(1) multiplied by the hazard rate in year 2 from column 3. Hence, P(N)=S(N−1) S(N) are calculated similarly.

Column (4) is the maximum death benefit DB from the policy.

Column (5) is the probability of the Life Insurance Company to survive PFS at year T. In first year, PFS(1), the probability of the company surviving year 1, is one minus the company hazard rate. As noted above, the hazard rate for process 300, assuming that the life insurance company's CDS premium is 130 bps, is 3.25% for a 60% recovery rate. The hazard rate is the probability of default in any single year. PFS(2) is equal to PFS(1) multiplied by one minus the hazard rate. Hence, PFS(N)=PFS(N−1) * [1−hazard rate].

Column (6) is the probability of the INSCO goes under PFG at year T. The PFG equals one minus the probability of the life insurance company to survive PFS at year T from column (5).

Column (7) is expected remaining policies or expected losses EL that have not lapsed at year T, assuming an annual lapsing rate of 3.00% for the example. Expected remaining policies EL at year 1 are equal to one minus the lapsing rate. At year 2, the percentage of remaining policies is equal to the percentage of remaining policies at year 1 multiplied by one minus the lapsing rate. Thus, EL(N)=EL(N−1) * [1−lapsing rate].

Column (8) is the expected loss claim amounts PNLG at year T under the credit hedge contract that policyholders would make to the credit protection writer upon default of the original life insurance company, adjusted for lapsing policies every year. Such expected claim amount PNLG is calculated as (a) the maximum claim amount DB, which is the death benefit in column (4) multiplied by one minus the life insurance company recovery rate (60%) minus the state guarantee funds ($500K in our example), multiplied by (b) the probability of death P in column (3), multiplied by (c) the probability of the Life Insurance Company to go under PFG in column (6), multiplied by (d) the expected remaining policies EL at year T in column (7). In short, PNLG=[DB * [1−INSCO recovery rate]−state guarantee funds]* [P * PFG * EL].

Column (9) is the NLG expected policy premium cash flows from one policyholder EPP, calculated as the probability of surviving S at year T in column (2) multiplied by the NLG Premium multiplied by the size of the policy in millions. In year 1, for example, the EPP would be equal to S(1)×$7,690×2 (for 2MM Policy Size). By discounting cash flows in column (8) at a discount rate of 7.0%, the process 300 determines the present value of CDS premiums paid by policyholder to hedge against such insurance provider's risk. In this example, the process 300 results in a fair NPV of $6,507. The fair NPV may be grossed up, such as by 150%, to find the NPV of CDS premiums (or “Credit Premium”) that is charged to the policyholder with respect to the subject technology, i.e. the life insurance company's credit hedge. In this example, the result is a $9,761 grossed-up NPV of CDS Premiums.

The process 300 calculates the annual credit premium, whose cash flows present value to the same amount. In order to do so, the process 300 discounts NLG expected premium cash flow for an individual in column (9). In the current example, the process finds a NPV of NLG Premiums expected to be paid by policyholder, which is $197,161. The process 300 then implies the ratio to NLG premium of the insurance as the gross up NPV of CDS premiums over NPV of NLG Premiums. In the current example, ratio to NLG premium is $9,761/$197,161=4.95%. The annual credit premium ACP is therefore in average 4.95% of policy premium level NLG through the life of the policyholder, i.e. 4.95% times $7,690 times 2, or a $761 annual credit premium ACP.

Column (10) is an expected pay-out cash flow PCDS from the investor to the writer of the protection against life insurance provider's default, calculated as the annual credit premium ACP ($761 in our example) multiplied by the probability of surviving S to year T calculated in column (2). In short, PCDS=ACP * S.

Column (11) is the expected cash flow from the credit protection writer's perspective EFC, calculated as the expected amount of credit premiums PCDS in column (10) multiplied by the percentage of remaining policyholders at year T, minus the expected amount of claims PNLG in year T of the remaining policyholders of column (8). In short, EFC=PCDS * (% of remaining policy holders)−PNLG.

Column (12) is the expected cash flow from one policyholder's perspective without the proposed hedge EFWOH, calculated as (a) the amount of death benefit DB in column (4) multiplied by the probability of death P in column (3) minus (b) the sum of (i) expected NLG Premium paid at year T in column (9) and (ii) the expected loss claim at year T, which is column (8) PNLG divided by column (7) EL, to adjust for policyholders' lapsing rate, which does not apply for one isolated policyholder. In short, EFWOH=DB * P−[NLG+PNLG/EL].

Column (13) is expected cash flow from the policyholder's perspective including proposed hedge EFWH, calculated as (a) the amount of death benefit DB in column (4) multiplied by the probability of death P in column (3) minus (b) the sum of expected NLG Premium paid by policyholder in column (9) and expected annual credit premium ACP at year T. In short, EFWH=DB * P−[NLG+ACP]

The process 300 can calculate the IRR of the credit protection writer from the column (11) EFC, and the policyholder without hedge and with hedge from column (12) and (13) respectively. Policyholders essentially hedge credit risk of the insuring company by giving an ACP of $761, which is 0.04% of the size of the original life insurance policy, to practically remove credit risk.

In view of the above, the subject technology includes an insurance contract which provides secondary credit protection. The benefits can be targeted in various ways. In one embodiment, a separate guarantor model utilizes a third party insurance company, bank, investment bank, clearinghouse or the like in which policies may be contracted. In another embodiment, a guarantor underwrites a rider on the original policy which, for an additional premium, provides credit protection by a highly rated third party. In still another embodiment, the environment 10 includes a specifically designed CDS, over-the-counter (“OTC”) or exchange, which (i) pays out upon life insurance company default on policyholder (at that part of the capital structure) and (ii) pays out only upon the death of the holder in the case of life insurance or annuity pay date in the case of an annuity.

A benefit of the subject technology is for the policyholders to practically remove all credit risk from their life insurance or annuity policies at minimal costs. The subject technology can offer a term credit hedge as well that would be in effect for a limited period of time such as 10, 15, 20 or 30 years, to lower even further the cost to the policyholder. The calculation of the premium would be similar to the one described previously, only with a shorter term and the relevant NLG Policy Premium for the term of the policy chosen. For example, the premium could be $805, $1,085, $1,425, $2,615 per $1MM of 10 year, 15 year, 20 year and 30 year policies respectively. The contracts could be turned into permanent at term if the policyholder wants to make the contract permanent, the contract premium being re-priced at the time of being made permanent.

In another embodiment, the subject technology provides servicing of policies. Still referring to FIG. 3, at step 318, the process 300 services the policies. Typically, more than one-quarter of all life insurance policy benefits go unclaimed and unpaid upon death of the insured due to long dormancy periods and because beneficiaries do not automatically know or remember that such policies exist. There are no national clearinghouses, no data collecting entities for the different carriers, no deed of record, no central repository for unclaimed life insurance policies, and virtually no effort is made by insurance companies to find the beneficiaries, as the insurance companies are not incentivized to pay out claims. As a matter of fact, it is generally the job of the beneficiary to notify the insurer of a policy owner's death and to claim the death benefit when the insured dies. Hence, the process 300 keeps track of the insured life and notifies beneficiaries to make sure that the policies get fully paid. The process 300 uses the social security number in a death master file to check if the insured is still alive on a periodic basis, and notifies beneficiaries of their right to claim the appropriate death benefits upon death of the insured. The subject technology's advantage to policyholder therefore can be two-fold: hedging credit risk of insurer, and make sure that the claims will be paid to beneficiaries when due.

Referring again to FIG. 2, the memory 20 stores a plurality of modules 22a, 22b that allow accomplishing the subject technology and, for example, the process 300 of FIG. 3. An instruction set module 22a provides instructions so that the microprocessor 18 can execute the analytical and computational steps of the subject technology. A data module 22b stores the necessary information such as HOLCO and INSCO data, statistical information such as Black & Scholes pricing model for American Put Option, the results of analysis and computations, and any other data necessary for the proper operation of the server 14 and environment 10 generally.

It will be appreciated by those of ordinary skill in the pertinent art that the functions of several elements may, in alternative embodiments, be carried out by fewer elements, or a single element. Similarly, in some embodiments, any functional element may perform fewer, or different, operations than those described with respect to the illustrated embodiment. Also, functional elements (e.g., modules, databases, interfaces, computers, servers and the like) shown as distinct for purposes of illustration may be incorporated within other functional elements in a particular implementation.

It should be appreciated that the subject technology can be implemented and utilized in numerous ways, including without limitation as a process, an apparatus, a system, a device, a server, a computer, a method for applications now known and later developed or a computer readable medium. These and other unique features of the systems and methods disclosed herein are readily apparent from the description above. While the invention has been described with respect to preferred embodiments, those skilled in the art will readily appreciate that various changes and/or modifications can be made to the invention without departing from the spirit or scope of the invention.

What is claimed is:

1. A server for providing secondary credit protection for holders of insurance and annuity policies issued by an insurance company, wherein the insurance company is a subsidiary of a holding company, the server comprising:
(a) a memory storing an instruction set and financial data related to an insurance company and a holding company; and
(b) a processor for running the instruction set, the processor being in communication with the memory, wherein the processor is operative to:
(i) determine a corporate bond price associated with a corporate bond of the holding company;
(ii) determine an interpolated swap rate for the bond based on the corporate bond price and premium;
(iii) determine a present weighted value of premiums associated with the corporate bond;
(iv) determine an overcollateralization ratio of the holding company;
(v) determine implied asset volatility for the corporate bond; and
(vi) determine an implied put price for the corporate bond and a CDS premium for the insurance company.

2. A server as recited in claim 1, wherein the processor is further operative to account for applicable state guarantees in determining the CDS premium.

3. A server as recited in claim 1, wherein the processor is further operative to a service policy associated with the CDS premium.

4. A server as recited in claim 1, wherein the corporate bond price is for a 27 year corporate bond but a model for the secondary credit protection extends a model term to desired term using a risk free rate to determine the CDS premium.

5. A server as recited in claim 1, wherein a 60% recovery rate is assumed when determining the present weighted value of premiums.

6. A server as recited in claim 1, wherein the overcollateralization ratio is total assets divided by total liabilities.

7. A server as recited in claim 1, wherein the server communicates with clients via a distributed computing network.

8. A method for providing insurance in a distributed computing network having a server and a plurality of clients, the method comprising the steps of:
determining a corporate bond price associated with a corporate bond of a holding company in the server;
determining an interpolated swap rate for the bond based on the corporate bond price and premium in the server;
determining a present weighted value of premiums associated with the corporate bond in the server;
determining an overcollateralization ratio of the holding company in the server;
determining implied asset volatility for the corporate bond in the server;
determining an implied put price for the corporate bond and a CDS premium for the insurance company in the server; and
offering a secondary credit protection product for users associated with the clients.

9. A method as recited in claim 8, wherein the offering is by an electronic exchange.

10. A method as recited in claim 8, wherein the offering is by a rider on an insurance policy of a user.

11. A method as recited in claim 8, wherein a third party purchases and aggregates the secondary credit product.

12. A method as recited in claim 11, wherein the third party resells the aggregated secondary products.
